(19) United States
(12) Patent Application Publication
(10) Pub. No.: US 2026/0304116 A1
(43) Pub. Date: Oct. 1, 2026

(54) COMMUNICATION APPARATUS, CONTROL METHOD FOR COMMUNICATION APPARATUS, AND STORAGE MEDIUM

(71) Applicant: CANON KABUSHIKI KAISHA, Tokyo (JP)

(72) Inventor: Yoshitaka Hata, Tokyo (JP)

(21) Appl. No.: 19/573,076

(22) Filed: Mar. 20, 2026

(30) Foreign Application Priority Data
Mar. 27, 2025 (JP) 2025-054524

(51) Int. Cl. H04W 12/06; H04W 48/20; H04W 76/10

(52) U.S. Cl. CPC H04W 12/06; H04W 48/20; H04W 76/10

(57) ABSTRACT

A communication apparatus capable of communicating with an external access point, the communication apparatus comprising: one or more processors; and one or more memories storing instructions that, when executed by the one or more processors, cause the communication apparatus to: accept, from among one or more access points that are candidates for a connection destination, selection of a connection access point to which a connection is set up; and control such that, in a case where an entry of a password is not required for connecting to the connection access point for which the selection is accepted, a first screen for guiding to an operation guide regarding the password is not displayed, and, in a case where an entry of the password is required, the first screen is displayed.

### BACKGROUND

### Field of the Technology

The present disclosure relates to a communication apparatus, a control method for a communication apparatus, and a storage medium.

### Description of the Related Art

In printers capable of wireless connection, a technology is known that allows a user to easily set up a connection to a network (Japanese Patent Laid-Open No. 2024-076634).

Japanese Patent Laid-Open No. 2024-076634 discloses a technology that performs network settings of a printer by operating the printer from a personal computer already connected to a Wi-Fi network.

There is a demand for improvement in usability in a case of setting up a connection of a communication apparatus to an access point.

### SUMMARY

A communication apparatus according to an embodiment of the present disclosure is a communication apparatus capable of communicating with an external access point, the communication apparatus comprising: one or more processors; and one or more memories storing instructions that, when executed by the one or more processors, cause the communication apparatus to: accept, from among one or more access points that are candidates for a connection destination, selection of a connection access point to which a connection is set up; and control such that, in a case where an entry of a password is not required for connecting to the connection access point for which the selection is accepted, a first screen for guiding to an operation guide regarding the password is not displayed, and, in a case where an entry of the password is required, the first screen is displayed.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a configuration of a wireless communication system;

FIG. 2 is a block diagram illustrating a configuration of a mobile terminal device;

FIG. 3 is a diagram illustrating an example of the outer appearance of the mobile terminal device;

FIG. 4 is a block diagram illustrating a configuration of a printer;

FIG. 5 is a diagram illustrating an example of the outer appearance of the printer;

FIG. 6 is a diagram illustrating an example of the outer appearance of an operation display unit of the printer;

FIG. 7A and FIG. 7B are diagrams illustrating an example of screens displayed on the operation display unit of the printer;

FIG. 8 is a flowchart illustrating the processing of setting up a connection to an access point;

FIG. 9 is a diagram illustrating an example of operation screens for setting up a connection to an access point;

FIG. 10 is a diagram showing the relationship between FIG. 10A and FIG. 10B

FIG. 10A and FIG. 10B are flowcharts illustrating the processing of setting up a connection to an access point;

FIG. 11 is a flowchart illustrating the details of determination whether to display a manual again; and

FIG. 12 is a diagram illustrating an example of operation screens for setting up a connection to an access point.

### DESCRIPTION OF THE EMBODIMENTS

Hereinafter, with reference to the accompanying drawings, a detailed description is given of embodiments of the present disclosure. Note that the following embodiments are not intended to limit the contents of the present disclosure, and all combinations of the characteristics described in the following embodiments are not necessarily essential to the solutions provided in the present disclosure. Note that the same reference numerals are given to the same constituent elements.

### First Embodiment

### <Outline>

A description is given of an outline of the first embodiment. Printers having a wireless LAN connection function are widely used in home or office environments, and a user can use such printers by connecting to a Wi-Fi (Wireless Fidelity) network. As methods for connecting to a Wi-Fi network, there are a method in which an external terminal such as a personal computer (hereinafter referred to as a PC) is utilized to set up a connection of a printer and a method in which a connection is set up directly from a printer to a Wi-Fi network. In a case of connecting to a Wi-Fi network directly from a printer, it is required to enter a password of a Wi-Fi router serving as an access point (hereinafter also referred to as an AP) from the printer main body.

However, a user may not know which password to enter, resulting in a failure of connection. Further, in printers, an initial password for utilizing a specific function is set for the purpose of protecting security. This initial password can sometimes be confused with the password of a Wi-Fi router and be entered by mistake. Therefore, it is important to improve usability by displaying an operation guide suitable for a user at the time of connecting to a Wi-Fi network, so that the user can set up a connection without confusion.

Thus, in a case of setting up a connection of a communication apparatus such as a printer to a Wi-Fi router serving as an AP, there is room for improving usability. In the embodiments described below, a description is given of an example of a communication apparatus that displays an operation guide suitable for a user at the time of setting up a connection to an AP, thereby making it possible to set up the connection easily.

### <System Configuration>

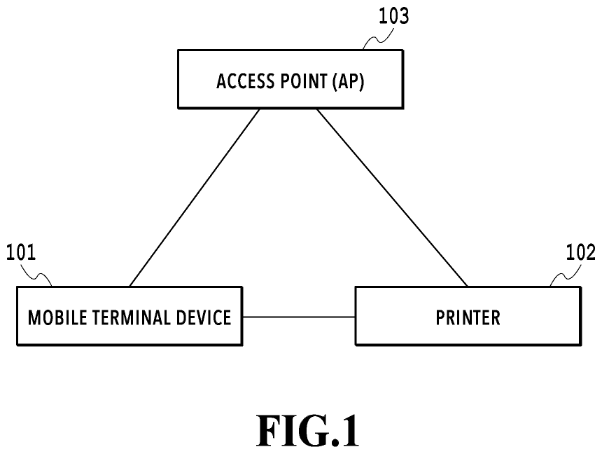

FIG. 1 is an example of a configuration of a wireless communication system in the present embodiment. The configuration of the present wireless communication system includes, for example, the mobile terminal device 101, the printer 102, and the AP 103. Each of these devices is a communication apparatus having a wireless communication function. However, there is no such limitation, and devices other than these may be included in addition to or in place of the illustrated devices.

In the present embodiment, a printer (an image forming apparatus) is described as an example of a communication apparatus; however, there is no such limitation, and various communication apparatuses are applicable as long as the communication apparatus can connect to an AP, which is described below. For example, in a case of a printer, application to an inkjet printer, a full-color laser beam printer, a monochrome printer, and the like is possible. Further, application is possible not only to a printer but also to a copier, a scanner device, a facsimile device, a smartphone, a tablet terminal, a PDA (Personal Digital Assistant), a digital camera, and the like.

The mobile terminal device 101 is, for example, a portable wireless communication apparatus having a communication function using a wireless LAN (WLAN). Note that, in this description, it is assumed that the communication function using a wireless LAN performs data (packet) communication in a wireless LAN system compliant with the IEEE 802.11 standard series, for example. The mobile terminal device 101 can use the wireless LAN communication function to perform communication based on Wi-Fi Direct, communication in a software AP mode, communication in an infrastructure mode, and the like.

Note that the mobile terminal device 101 may have a wireless communication function other than the wireless LAN compliant with the IEEE 802.11 standard series. For example, the mobile terminal device 101 may have a wireless LAN compliant with a standard other than the IEEE 802.11 standard series, or a communication function other than a wireless LAN. However, it is assumed that the mobile terminal device 101 can operate in either a first mode, in which wireless communication with a counterpart device is performed via another device (an AP), or a second mode, in which wireless communication with a counterpart device is directly performed without intervention by another device. The mobile terminal device 101 may be a personal information terminal such as a PDA, a mobile phone, a digital camera, or the like.

The printer 102 is a communication apparatus that has a communication function for performing wireless communication with the mobile terminal device 101. That is, the printer 102 is a communication apparatus capable of wireless connection to the AP 103 and the mobile terminal device 101. The printer 102 may further have a reading function (a scanner function), a facsimile function, a telephone function, and the like. Note that the wireless communication function is assumed to be a function corresponding to the communication function possessed by the above-described mobile terminal device 101. That is, in a case where the mobile terminal device 101 has a communication function using a wireless LAN, the printer 102 is assumed to have a communication function using a wireless LAN of the same standard, for example. In the present embodiment, the printer 102 has a reading function in addition to a printing function; however, there is no such limitation, and the printer 102 may have only the printing function, or may have a function not related to image processing such as printing.

The AP 103 has a communication function using a wireless LAN, and relays communication between communication apparatuses (in the present embodiment, the mobile terminal device 101 and the printer 102) that function as wireless LAN stations to which connection to the AP 103 is permitted. That is, the AP 103 is capable of wireless connection. In the present embodiment, an example in which the AP 103 is a Wi-Fi router is described. Communication apparatuses (stations) present around the AP 103 can perform communication in an infrastructure mode via the AP 103. Note that, in a case where the mobile terminal device 101 communicates with a counterpart device via another device by using a communication function other than a wireless LAN, the AP 103 can be replaced with the said another device.

The mobile terminal device 101 and the printer 102 can perform wireless communication in an infrastructure mode via the AP 103, using their respective wireless LAN communication functions. Further, the mobile terminal device 101 and the printer 102 can also perform wireless communication in a P2P mode in accordance with Wi-Fi Direct or the like.

### <Configuration of the Mobile Terminal>

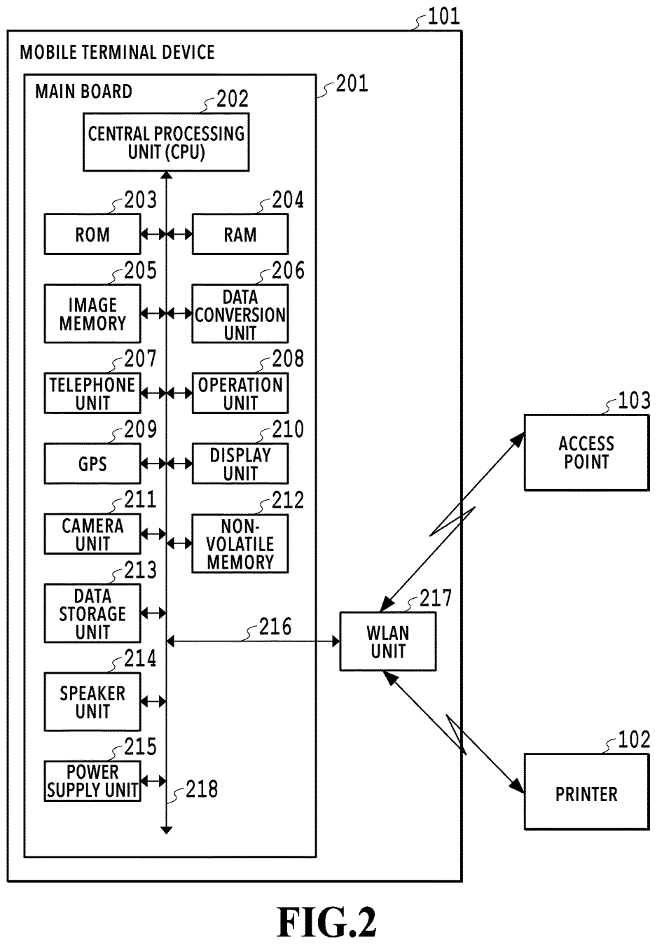

FIG. 2 is a block diagram illustrating a configuration of the mobile terminal device 101. In one example, the mobile terminal device 101 includes the main board 201 for performing main control of the device itself and the WLAN unit 217 for communication using a wireless LAN.

In the main board 201, the CPU (central processing unit) 202 is a system control unit, and controls overall operations of the mobile terminal device 101. Processing performed by the mobile terminal device 101 described below is executed under control of the CPU 202, for example. Note that the mobile terminal device 101 may use an application specific integrated circuit (ASIC), a field programmable gate array (FPGA), or the like in order to implement at least part of its functions.

The ROM 203 stores control programs executed by the CPU 202, programs of an embedded operating system (OS), and the like. The RAM 204 is constituted by an SRAM (Static Random Access Memory) or the like, and stores data such as program control variables as well as data such as setting values registered by a user and management data of the mobile terminal device 101. The RAM 204 is equipped with buffer areas for various kinds of works. The image memory 205 is constituted by a memory such as a DRAM (Dynamic RAM), and temporarily stores image data received via the WLAN unit 217 and image data read out from the data storage unit 213 for processing by the CPU 202. The non-volatile memory 212 is constituted by a memory such as a flash memory, and continues to store data even in a state where power of the mobile terminal device 101 is turned off. Note that such memory configurations are not limited to the above-described configurations, and for example, the image memory 205 and the RAM 204 may be shared, or data backup or the like may be performed in the data storage unit 213. Note that, although the image memory 205 is described above as being constituted by a DRAM, the image memory 205 may be constituted by another storage medium such as a hard disk or a non-volatile memory.

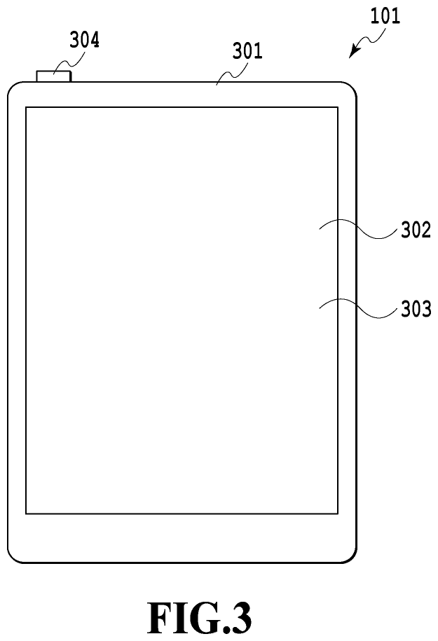

The data conversion unit 206 analyzes data in various formats and performs data conversion such as color conversion or image conversion. The telephone unit 207 processes audio data input and output via the speaker unit 214, thereby generating a signal for a voice call and transmitting the signal to a communication line, or restores audio data from a signal received from the communication line. The operation unit 208 generates and outputs a signal representing an operation accepted via the later-described operation unit 303 of FIG. 3. The GPS (Global Positioning System) 209 obtains position information such as the current latitude and longitude of the mobile terminal device 101. The display unit 210 electronically controls displayed contents of the display unit 302 of FIG. 3, and is capable of displaying a screen for various input operations, displaying an operation status of the printer 102, displaying a status situation, and the like.

The camera unit 211 has a function of electronically recording and encoding an image input via a lens. Image data relating to an image captured by the camera unit 211 is stored in the data storage unit 213. The data storage unit 213 can be a storage device in which various types of data are stored as described above. The speaker unit 214 realizes a function of inputting or outputting audio for a telephone function and other functions such as alarm notification. The power supply unit 215 is a battery in a size that can be housed inside the mobile terminal device 101, and controls power supply into the device.

The mobile terminal device 101 can be in any one of the following power states: a battery-dead state in which there is no remaining battery level, a power-off state in which the power key 304 of FIG. 3 is not pressed, an activated state in which the device is activated normally, and a power-saving state in which the device is activated but is in a power-saving mode.

The configuration of the WLAN unit 217 includes an antenna and a communication circuit (for example, a circuit having a baseband processing function and an RF processing function) for performing wireless communication compliant with a wireless LAN standard. The mobile terminal device 101 performs data communication using a wireless LAN via the WLAN unit 217 with another device such as a printer as a counterpart device. The WLAN unit 217 can convert data into packets and wirelessly transmit the packets to another device, and can receive packets wirelessly transmitted from another external device, restore the packets to original data, and transmit the restored data to the CPU 202.

Each constituent element within the main board 201 is interconnected via the system bus 218 managed by the CPU 202. Further, the WLAN unit 217 is also connected to the system bus 218 within the main board 201 via the bus cable 216. Accordingly, under control of the CPU 202, data generated or stored in various constituent elements within the main board 201 are transmitted via the WLAN unit 217, and data received by the WLAN unit 217 are transferred to various constituent elements within the main board 201. Note that the mobile terminal device 101 may have functions that a general smartphone has, such as a communication function for cellular communication.

### <Outer Appearance of the Mobile Terminal>

In FIG. 3, an example of the outer appearance of the mobile terminal device 101 is illustrated. In the present embodiment, a description is given of a case in which the mobile terminal device 101 is a smartphone. A smartphone is a multifunctional mobile phone equipped with various functions such as a camera, a web browser, and an email function. However, the mobile terminal device 101 does not need to be a smartphone. For example, the mobile terminal device 101 may be a digital camera, a mobile phone, a laptop PC, a tablet terminal, a PDA (Personal Digital Assistant), a music playback device, or the like.

The mobile terminal device 101 may include, for example, a touch panel in which the display unit 302 and the operation unit 303 are integrated, and may include a portion of the bezel 301 that fixes or protects the touch panel. Note that an antenna for performing communication using a wireless LAN or the like may be installed on the back surface of the bezel 301. The mobile terminal device 101 can perform communication using the antenna and a wireless communication circuit or the like. That is, the mobile terminal device 101 is capable of communicating with the external access point (AP) 103. Further, the mobile terminal device 101 is capable of communicating with the later-described printer 102 as well.

The display unit 302 and the operation unit 303 may be, for example, a touch-panel display equipped with a display mechanism of an LCD system. For example, the display unit 302 displays button icons and a software keyboard, and the operation unit 303 can detect operation events in response to the user touching these portions. The power key 304 is a hard key for receiving operations such as turning on and turning off power supply.

### <Configuration of the Printer>

forming apparatus. As described above, the printer 102 also serves as a communication apparatus. In one example, the printer 102 includes the main board 401 for performing main control of the apparatus itself, the WLAN unit 416 for communication using a wireless LAN, the wired LAN unit 417 for wired communication, and the USB unit 415 for USB connection. That is, the printer 102 is capable of communicating with the external access point (AP) 103. Further, the printer 102 is capable of communicating with the above-described mobile terminal device 101 as well.

In the main board 401, the CPU 402 is a system control unit, and controls an overall operation of the printer 102. Processing performed by the printer 102 described below is executed under control of the CPU 402, for example. Note that the printer 102 may use an application specific integrated circuit (ASIC), a field programmable gate array (FPGA), or the like in order to implement at least part of its functions.

The ROM 403 stores control programs executed by the CPU 402, programs of an embedded OS, and the like. In the present embodiment, each control program stored in the ROM 403 performs software control such as scheduling and task switching under management of an embedded OS stored in the ROM 403. The RAM 404 is constituted by an SRAM or the like, and stores data such as program control variables as well as data such as setting values registered by a user and management data of the printer 102. The RAM 404 is equipped with buffer areas for various kinds of works. The non-volatile memory 405 is constituted by a memory such as a flash memory, and continues to store data even in a state where power of the printer 102 is turned off. The image memory 406 is constituted by a memory such as a DRAM, and stores image data received via the WLAN unit 416, image data processed in the encoding/decoding processing unit 411, and the like. Further, similarly to the memory configuration of the mobile terminal device 101, the memory configuration of the printer 102 is not limited to the above-described configuration.

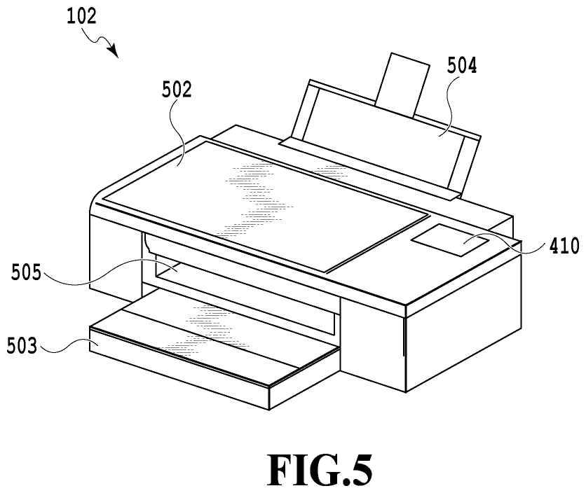

The reading control unit 407 controls the reading unit 409 (for example, a CIS (Contact Image Sensor)) to optically read a document placed on the later-described document table 502 of FIG. 5 and generate, as an output, an image signal obtained by converting the read document into electrical image data. At this time, the reading control unit 407 may output image data obtained as a result of various kinds of image processing such as binarization processing and halftone processing. The data conversion unit 408 performs analysis of data in various formats, conversion from image data into print data, and the like.

The operation display unit 410 corresponds to the operation display unit 410 of FIG. 5. The operation display unit 410 generates a signal representing a user operation accepted via the operation display unit 410 of FIG. 5, and controls information to be displayed on the operation display unit 410 of FIG. 5. The encoding/decoding processing unit 411 performs encoding processing, decoding processing, and enlargement/reduction processing of image data (JPEG, PNG, or the like) handled in the printer 102.

The paper feeding unit 413 holds printing paper and feeds the printing paper for printing under control from the print control unit 414. The paper feeding unit 413 may include multiple paper feeding units in order to hold multiple types of printing paper in one apparatus. In this case, the print control unit 414 can control from which paper feeding unit printing paper is to be fed. The print control unit 414 performs various kinds of image processing, such as smoothing processing, print density correction processing, and color correction, on image data as a printing target, and outputs the processed image data to the printing unit 412. The printing unit 412 may be, for example, a circuit and a mechanism that function as an inkjet printer that prints an image by ejecting ink, which is supplied from an ink tank, from a print head. Further, the print control unit 414 can also perform control to periodically read out information of the printing unit 412 and update information stored in the RAM 404. For example, the print control unit 414 can update status information stored in the RAM 404, such as a remaining amount of ink in an ink tank and a state of a print head.

The configuration of the USB unit 415 includes an interface and a circuit for connecting to an external PC or the like via a USB cable. The USB unit 415 is configured to realize communication compliant with a USB standard, and the USB unit 415 enables one-to-one communication with an external device such as a PC connected via a USB cable.

The NW (network) sub-system 420 is a sub-system that performs input/output control related to network communication in order to reduce a control load of the CPU 402. In a part of the RAM 404, control code to be executed by the NW sub-CPU 421 is stored, and in the boot sequence of the CPU 402, the control code is DMA-transferred from the RAM 404 to the RAM 422 in the NW sub-system 420. The control code is executed by the NW sub-CPU 421 after release from reset of the NW sub-CPU 421, and thereby, input/output control related to network communication is carried out. Each module within the NW sub-system (the NW sub-CPU 421, the RAM 422, and the UHOST module 423) is interconnected via the local bus 424, which is separated from the system bus 418 of the main board 401. The NW sub-system 420 makes it possible to perform network control that minimizes influence on other modules within the main board 401 by performing, in particular, functions of a layer close to the hardware layer among functions related to network communication.

The WLAN unit 416 is connected to the NW sub-system 420 via, for example, the USB bus 425 and the UHOST module 423. The configuration of the wired LAN unit 417 includes a circuit and mechanism for performing data (packet) communication compliant with, for example, the IEEE 802.3 standard series. For example, the wired LAN unit 417 includes an Ethernet (registered trademark) interface, is connected to a LAN by a cable connected to the interface, and enables communication with an external device such as a PC also connected to the LAN. Further, the wired LAN unit 417 is also able to communicate, via a wired LAN, with a wireless communication device or the like connected to a Wi-Fi router connected to the wired LAN. The wired LAN unit 417 is connected to the main board 401 via the local bus 424 within the NW sub-system 420. Note that each constituent element within the main board 401 is interconnected via the system bus 418 managed by the CPU 402.

### <Outer Appearance of the Printer>

In FIG. 5, an example of the outer appearance of the printer 102, which is an image forming apparatus, is illustrated. As described above, the printer 102 also serves as a communication apparatus. The printer 102 includes the operation display unit 410, the document table 502, the paper feed cassette 503, the paper feed tray 504, and the paper discharge port 505.

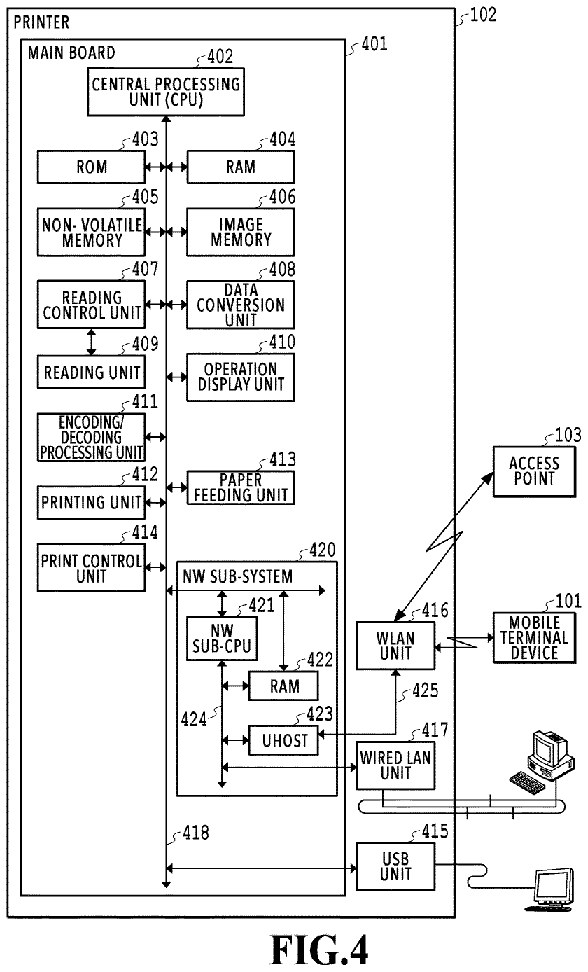

The document table 502 is a table on which a document to be scanned by the reading unit 409 of FIG. 4 is set. The paper feed cassette 503 is a first paper feed port in which printing paper is set in the paper feeding unit 413 of FIG. 4. The paper feed tray 504 is a second paper feed port in which printing paper is set in the paper feeding unit 413 of FIG. 4. The paper discharge port 505 discharges printing paper on which printing has been completed.

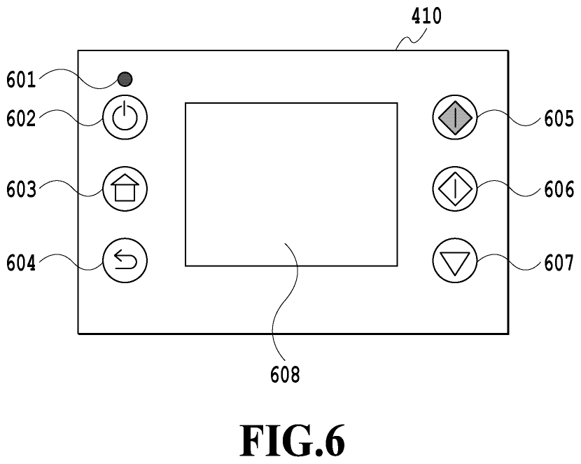

Next, a detailed description is given of a configuration of the operation display unit 410. FIG. 6 is an external view illustrating an example of the operation display unit 410 of the printer 102. The operation display unit 410 of the printer 102 includes the LED 601, the power button 602, the home button 603, and the back button 604. The operation display unit 410 further includes the color start button 605, the monochrome start button 606, and the stop button 607.

The LED 601 lights up in the state where the power supply of the printer 102 is on. The power button 602 is a button for switching the power supply of the printer 102 on and off.

The home button 603 is a button for displaying a home screen. The back button 604 is a button for bringing a screen displayed on the later-described LCD 608 back to a previous state. The color start button 605 is a button for executing color copying and color scanning. The monochrome start button 606 is a button for executing monochrome copying and monochrome scanning. The stop button 607 is a button for cancelling an operation of the apparatus such as printing and scanning.

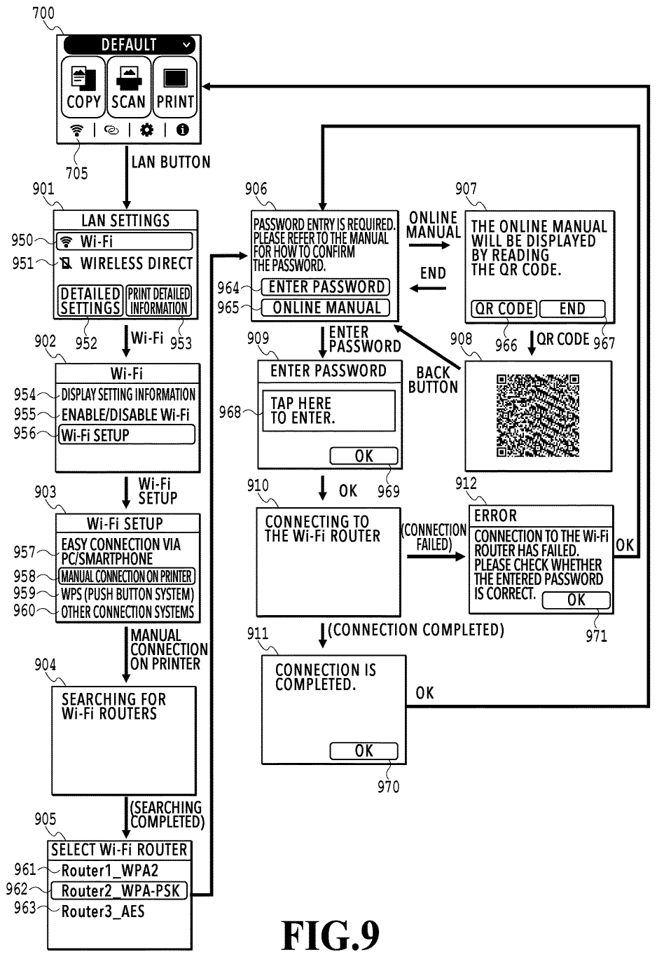

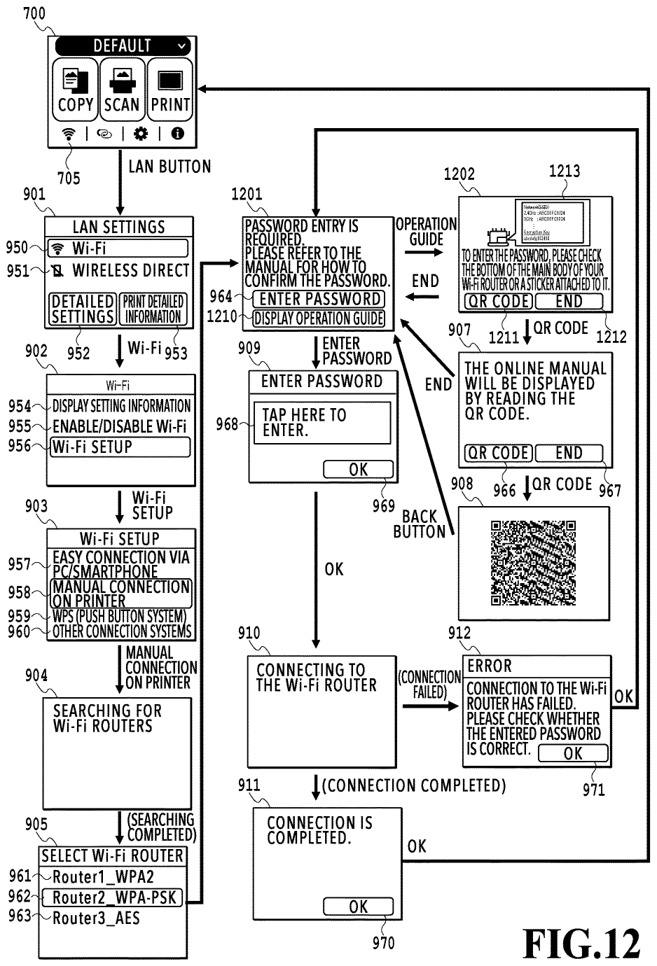

The LCD 608 displays various types of information to a user through a screen, and also has a touch sensing function that detects a touch operation on the screen by a user. As described later, the LCD 608 displays various operation screens (for example, respective screens in FIG. 9 and FIG. 12 described later). Note that, in the example illustrated in FIG. 6, the home button 603, the back button 604, the color start button 605, the monochrome start button 606, and the stop button 607 are hard buttons arranged in the vicinity of the LCD 608. These buttons may be soft buttons displayed within a screen of the LCD 608.

### <Home Screen of the Printer>

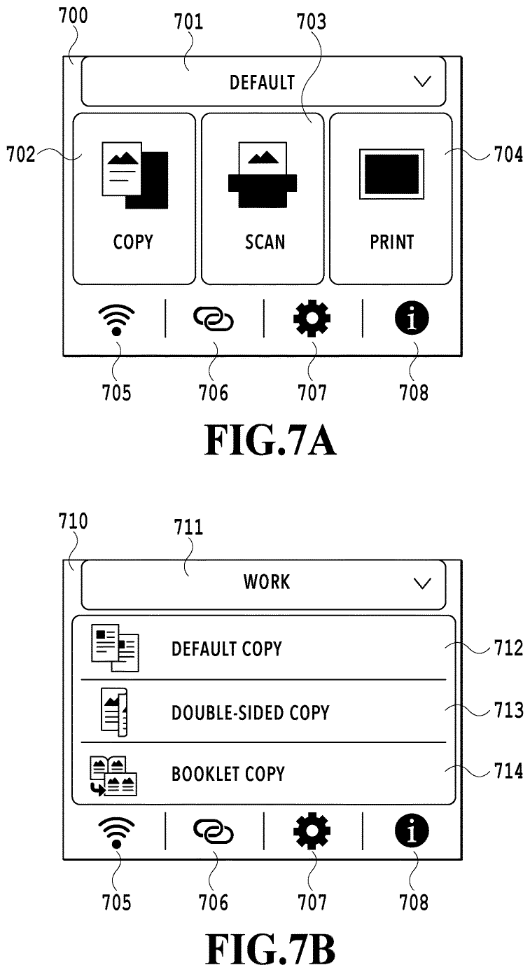

Next, a detailed description is given of a home screen displayed on the LCD 608 in the operation display unit 410 of the printer 102. FIG. 7A and FIG. 7B are diagrams illustrating an example of displayed contents of a home screen displayed on the LCD 608 in the operation display unit 410 of the printer 102.

In FIG. 7A, the default home screen 700 is illustrated. Information about a home screen that is valid at that point in time and is held in the non-volatile memory 405 of the printer 102 appears as the state of the default home screen 700. Further, the home screen is displayed at the time the power supply of the printer 102 is turned on, or at the time the home button or the back button 604 is pressed on a screen other than the home screen.

In the default home screen 700, as illustrated in FIG. 7A, the home screen switching button 701 is arranged in an upper portion. The home screen switching button 701 is a button for switching a home screen, and in the example of FIG. 7A, “DEFAULT,” which indicates that the currently selected home screen is a default home, is displayed.

In a middle portion of the default home screen 700, as illustrated in FIG. 7A, the copy menu button 702, the scan menu button 703, and the print menu button 704 are arranged. Furthermore, in a lower portion of the default home screen 700, the LAN button 705, the wireless connect button 706, the setting button 707, and the hint button 708 are arranged.

By a user touching and selecting each of the above-described buttons, a transition is made to a screen corresponding to each button. For example, in a case where the copy menu button 702 is selected, an area for inputting copy settings, a screen for instructing execution of copying, or the like is displayed. If the user presses the color start button 605 of FIG. 6 on that screen, execution of color copying is thereby started. Similarly, if the user presses the monochrome start button 606 in a state where the copy menu button 702 is selected, execution of monochrome copying is thereby started.

In the present embodiment, three custom home screens are present other than the default home screen 700, and a user can select any desired home screen. In FIG. 7B, an example of displayed contents of the “WORK” home screen 710, which is one of the custom home screens, is illustrated. The home screen switching button 711 in an upper portion of the “WORK” home screen 710 is displayed as “WORK,” which indicates the current home screen.

In a middle portion of the “WORK” home screen 710, custom buttons which can be freely registered by a user are arranged. In the example of FIG. 7B, the “DEFAULT COPY” 712, the “DOUBLE-SIDED COPY” 713, and the “BOOKLET COPY” 714 are registered. By selecting each custom button, a transition can be made to a screen for executing a registered function.

In a lower portion of the “WORK” home screen 710, similarly to the default home screen 700, the LAN button 705, the wireless connect button 706, the setting button 707, and the hint button 708 are arranged. As a custom home screen, a “STUDY” home screen, a “LIFE” home screen, or the like, can be displayed other than the “WORK” home screen. Switching of the home screen can be selected on a home selection screen, which is displayed by operating the home screen switching button 701 (711).

### <Connecting the Printer to the AP>

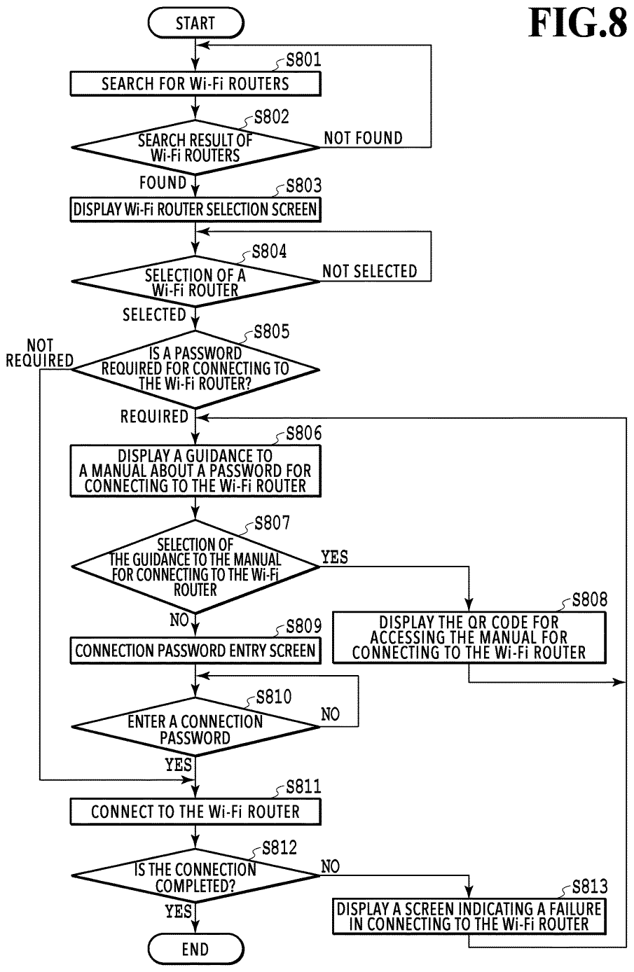

FIG. 8 is a flowchart for setting up a connection of the printer 102 to a Wi-Fi router serving the AP 103 in the present embodiment. In other words, it is a flowchart for setting up a connection of the printer 102 to a Wi-Fi network. Further, FIG. 9 is an example of operation screens displayed on the LCD 608 of the operation display unit 410 in the printer 102 at the time of setting up a connection of the printer 102 to a Wi-Fi network.

The processes in the flowchart illustrated in FIG. 8 are implemented by the CPU 402 of the printer 102 reading out a program stored in the ROM 403 or the like into the RAM 404 and executing it. Note that, as described above, functions related to network communication, such as a search for connectable APs and connection to an AP, are executed by the NW sub-CPU 421 in the NW sub-system 420. Note that part or all of the functions in the steps of FIG. 8 may be implemented by hardware such as an ASIC or an electronic circuit. The symbol “S” in the description of each process indicates that it is a step in the flowchart (the same applies hereinafter to the flowcharts of the present specification).

The start of the flowchart of FIG. 8 is triggered by selection of the “MANUAL CONNECTION ON PRINTER” 958 in the Wi-Fi setup screen 903 of FIG. 9 on the operation display unit 410 of the printer 102. Therefore, first, with reference to FIG. 9, a description is given of the display screens and operations up to the selection of the “MANUAL CONNECTION ON PRINTER” 958 in the Wi-Fi setup screen 903.

The operation screens for setting up a connection of the printer 102 to a Wi-Fi network start from the default home screen 700 in FIG. 9. As described above, the default home screen 700 is displayed at the time the power supply of the printer 102 is turned on, or at the time the home button or the back button 604 is pressed on a screen other than the home screen.

The CPU 402 of the printer 102, upon detecting an operation of the LAN button 705 on the default home screen 700, displays the LAN setting screen 901. Note that, even in a custom home screen, if the LAN button 705 is arranged, by operating the LAN button 705 in the custom home screen, a transition can be made to the LAN setting screen 901.

In the LAN setting screen 901, the “Wi-Fi” 950 and the “WIRELESS DIRECT” 951 are displayed, and a user can select either one of them. The “Wi-Fi” 950 is selected at the time of performing basic settings of an infrastructure mode of a wireless LAN. The “WIRELESS DIRECT” 951 is selected at the time of performing basic settings of a wireless direct mode. Furthermore, the LAN setting screen 901 includes the detailed settings button 952 and the detailed information print button 953. The detailed settings button 952 is used at the time of performing detailed settings. The detailed information print button 953 is used at the time of printing setting information related to a LAN on printing paper using the printing unit 412. In the present embodiment, an example of setting up a connection to a Wi-Fi router is described, and thus, it is assumed that the “Wi-Fi” 950 is selected. The CPU 402 of the printer 102, upon detecting selection of the “Wi-Fi” 950, displays the Wi-Fi screen 902.

In the Wi-Fi screen 902, the “DISPLAY SETTING INFORMATION” 954, the “ENABLE/DISABLE Wi-Fi” 955, and the “Wi-Fi SETUP” 956 are displayed, and a user can select any one of them. The “DISPLAY SETTING INFORMATION” 954 is selected at the time of displaying a setting state related to Wi-Fi. The “ENABLE/DISABLE Wi-Fi” 955 is selected at the time of switching enabling/disabling of a wireless LAN infrastructure mode. The “Wi-Fi SETUP” 956 is selected at the time of setting up a connection to a Wi-Fi router. In the present embodiment, an example of setting up a connection to a Wi-Fi router is described, and thus, it is assumed that the “Wi-Fi SETUP” 956 is selected. The CPU 402, upon detecting selection of the “Wi-Fi SETUP” 956, displays the Wi-Fi setup screen 903.

In the Wi-Fi setup screen 903, the “EASY CONNECTION VIA PC/SMARTPHONE” 957, the “MANUAL CONNECTION ON PRINTER” 958, the “WPS (PUSH BUTTON SYSTEM)” 959, and the “OTHER CONNECTION SYSTEMS” 960 are displayed, and a user can select any one of them. The “EASY CONNECTION VIA PC/SMARTPHONE” 957 is selected at the time of setting up a network for the printer 102 using a PC/smartphone. The “MANUAL CONNECTION ON PRINTER” 958 is selected at the time of manually connecting to a Wi-Fi router designated from the printer 102. The “WPS (PUSH BUTTON SYSTEM)” 959 is selected at the time of setting up a connection using a WPS button of a Wi-Fi router. The “OTHER CONNECTION SYSTEMS” 960 is selected at the time of selecting another connection system, including WPS (PIN system). In the present embodiment, an example of manually setting up a connection from the printer 102 to a Wi-Fi router is described, and thus, it is assumed that the “MANUAL CONNECTION ON PRINTER” 958 is selected.

As described above, the start of the flowchart of FIG. 8 is triggered by selection of the “MANUAL CONNECTION ON PRINTER” 958 in the Wi-Fi setup screen 903 of FIG. 9 on the operation display unit 410 of the printer 102. That is, the CPU 402, upon detecting selection of the “MANUAL CONNECTION ON PRINTER” 958, starts processing of the flowchart of FIG. 8 and displays the AP search screen 904.

Hereinafter, with reference to the flowchart of FIG. 8 corresponding to the operation screens in FIG. 9, a description is given of a processing flow of setting up a connection of the printer 102 to a Wi-Fi network in the present embodiment.

In S801, the NW sub-CPU 421 in the NW sub-system 420 performs a search for connectable Wi-Fi routers present on the Wi-Fi network. While searching for connectable Wi-Fi routers, the CPU 402 of the printer 102 displays the AP search screen 904 of FIG. 9 on the LCD 608.

Next, in S802, the NW sub-CPU 421 determines whether a Wi-Fi router is found as a result of the search for Wi-Fi routers. In a case where no Wi-Fi router is found, the NW sub-CPU 421 returns to S801 and performs a search for Wi-Fi routers again. In a case where a Wi-Fi router is found, the CPU 402 proceeds to S803.

In S803, the CPU 402 displays, on the LCD 608, the Wi-Fi router found as a result of the search for Wi-Fi routers. That is, the CPU 402 displays, on the LCD 608, connectable access points as a search result for Wi-Fi routers, which serve as access points. In a case where multiple Wi-Fi routers are found, the multiple Wi-Fi routers are displayed so that selection can be made from among them. The Wi-Fi router selection screen 905 in FIG. 9 is an example of a screen displayed in a case where multiple Wi-Fi routers are found. In the Wi-Fi router selection screen 905, the connection destination candidate 961, the connection destination candidate 962, and the connection destination candidate 963 are connectable Wi-Fi routers found as a result of the search. These Wi-Fi routers, which are connectable APs, are displayed on the LCD 608 (the operation display unit 410) and are selectable on the LCD 608 as an AP to which a connection is to be set up. Hereinafter, an AP selected as an AP to which a connection is to be set up is referred to as a connection access point (also referred to as a connection AP).

Next, in S804, the CPU 402 detects whether a Wi-Fi router to be a connection AP, to which a connection is to be set up, has been selected from among the APs displayed on the Wi-Fi router selection screen 905. In a case where a selected Wi-Fi router is detected, the CPU 402 accepts the detected selection of a connection AP, and proceeds to S805. That is, the CPU 402 accepts selection of a connection AP to which a connection is to be set up from among the APs displayed on the Wi-Fi router selection screen 905. In a case where no Wi-Fi router is detected, the CPU 402 waits, in S804, for selection of a Wi-Fi router to be detected. Note that selection of a Wi-Fi router is performed by a user operation.

In a case where selection of a Wi-Fi router to be a connection AP is detected in S804, the CPU 402 determines in S805 whether entry of a password is required for Wi-Fi connection of the Wi-Fi router that is the accepted connection AP. Whether or not an entry of a password is required is determined depending on security settings of the Wi-Fi router. The CPU 402 obtains information related to security settings at the time of searching for Wi-Fi routers in S802. Then, based on the information related to the security settings of the connection AP, the CPU 402 determines whether or not an entry of a password is required. In a case where it is determined that an entry of a password is not required, the CPU 402 proceeds to S811, and in a case where it is determined that an entry of a password is required, the CPU 402 proceeds to S806.

In a case where it is determined in S805 that an entry of a password is not required and the processing proceeds to S811, the NW sub-CPU 421 executes connection to the selected Wi-Fi router. While connection to the Wi-Fi router is being executed, the CPU 402 displays the AP connection screen 910 of FIG. 9 on the LCD 608.

On the other hand, in a case where it is determined that an entry of a password is required and the processing proceeds to S806, the CPU 402 displays, on the LCD 608, a selection screen for guiding to an online manual in which an operation guide regarding an entry of a password for a Wi-Fi router is described. The guidance display screen 906 of FIG. 9 (also referred to as a first screen) is an example of a screen for guiding to an online manual in which an operation guide regarding an entry of a password for a Wi-Fi router is described. The guidance display screen 906 includes the password entry button 964 and the online manual button 965 (also referred to as a first operation area). The relationship between pressing of each button and the flowchart is described in the next step.

Next, in S807, the CPU 402 determines whether selection of the manual guidance for connection to a Wi-Fi route has been made. That is, the CPU 402 determines whether to display an online manual in which an operation guide regarding a password for a Wi-Fi router is described. In a case where it is determined to display the online manual (that is, in a case where it is determined that selection of the manual guidance for connection to a Wi-Fi router has been made), the processing proceeds to S808, and otherwise, the processing proceeds to S809. Whether to display the online manual is determined depending on which button press is detected by the CPU 402, namely, either the password entry button 964 or the online manual button 965 (the first operation area) in the guidance display screen 906 (the first screen) of FIG. 9. In a case where pressing of the online manual button 965 is detected, the CPU 402 determines to display the online manual, and the processing proceeds to S808. On the other hand, in a case where pressing of the password entry button 964 is detected, the CPU 402 determines not to display the online manual, and the processing proceeds to an entry of a password for connection to the Wi-Fi router in S809. That is, the guidance display screen 906, which is the first screen, guides to an operation guide regarding a password required for connection to a Wi-Fi router. Note that pressing of the password entry button 964 and pressing of the online manual button 965 are performed by user operations. Accordingly, the user can select whether to check the online manual. That is, for a user who already knows the operation method, connection to the Wi-Fi router can be performed without displaying the online manual, thereby improving usability.

In a case where pressing of the online manual button 965 is detected in S807 (the guidance display screen 906), in S808, the CPU 402 displays a QR code (registered trademark) for accessing the online manual regarding a password for connection to a Wi-Fi router. Display of the online manual is performed through the two-dimensional code explanation screen 907 of FIG. 9 (also referred to as a second screen) and the two-dimensional code screen 908 (also referred to as a third screen). Note that transition may be made directly from the guidance display screen 906 to the two-dimensional code screen 908 without displaying the two-dimensional code explanation screen 907.

The two-dimensional code explanation screen 907 (the second screen) of FIG. 9 is a screen that is displayed on the LCD 608 after the CPU 402 detects pressing of the online manual button 965 (the first operation area), and provides an explanation regarding display of the online manual. In the explanation screen 907, an explanatory sentence regarding the two-dimensional code “THE ONLINE MANUAL WILL BE DISPLAYED BY READING THE QR CODE.” is displayed. Furthermore, the explanation screen 907 includes the QR code button 966 (also referred to as a second operation area) and the end button 967.

The CPU 402, upon detecting selection of the QR code button 966 (the second operation area), displays the two-dimensional code screen 908 (the third screen) on the LCD 608. In the two-dimensional code screen 908, a figure obtained by converting the contents of the URL of an online manual, in which an operation guide regarding a password for a Wi-Fi router is described, into a two-dimensional code is displayed. In the present embodiment, a description is given of an example in which a QR code is used as the two-dimensional code. The online manual in which an operation guide regarding a password for a Wi-Fi router is described can be accessed from the two-dimensional code screen 908. That is, the two-dimensional code screen 908 displays a figure obtained by converting the contents of the URL of the online manual, in which an operation guide regarding a password for a Wi-Fi router is described, into a QR code, which is a two-dimensional barcode. This QR code is captured, for example, by the camera unit 211 of the mobile terminal device 101 (for example, a smartphone). Then, the mobile terminal device 101, with its installed functions, can access the online manual in which an operation guide regarding a password for connection to a Wi-Fi router is described without entering the URL, and can display the online manual on a browser of the mobile terminal device 101. In this online manual, an operation guide regarding a password is described. In other words, the online manual is an operation guide regarding a password. Therefore, the user can set up a connection of the printer to the AP 103 while checking the online manual regarding an entry of a password for AP connection. That is, usability in setting up a connection of the printer 102 to the AP 103 can be improved.

A summary is herein given of screen operations up to accessing an online manual in which an operation guide regarding a password for connection to a Wi-Fi router is described. In order to access the online manual, three screens are used, namely, the guidance display screen 906 (the first screen) of FIG. 9, the explanation screen 907 (the second screen) for displaying a two-dimensional code, and the two-dimensional code screen 908 (the third screen). In a case where the online manual button 965 (the first operation area) is pressed in the guidance display screen 906 (the first screen), the explanation screen 907 (the second screen) for displaying a two-dimensional code, which is a two-dimensional code for accessing the online manual, is displayed. Then, in a case where the QR code button 966 (the second operation area) is pressed in the explanation screen 907 (the second screen), the two-dimensional code screen 908 (the third screen) is displayed. Such screen display control is executed by the CPU 402 based on user operations.

The guidance display screen 906 (the first screen) is a screen for guiding to the online manual, which is an operation guide regarding a password for connection to a Wi-Fi router. The explanation screen 907 (the second screen) is a screen in which an explanation for displaying a two-dimensional code for accessing the online manual is displayed. Furthermore, the online manual button 965 (the first operation area) is a button for transitioning from the guidance display screen 906 (the first screen) to the explanation screen 907 (the second screen). The QR code button 966 (the second operation area) is a button for transitioning from the explanation screen 907 (the second screen) to the two-dimensional code screen 908 (the third screen). Note that pressing of the online manual button 965 (the first operation area) and pressing of the QR code button 966 (the second operation area) are performed by user operations.

In a situation where the two-dimensional code screen 908 is displayed after displaying the online manual, in a case where the back button 604 of FIG. 6 is pressed, transition can be made to return to the guidance display screen 906. Further, in the explanation screen 907, in a case where the two-dimensional code need not be displayed, transition can be made to return to the guidance display screen 906 by pressing the end button 967. That is, in a case where the CPU 402 detects that the back button 604 is pressed in the two-dimensional code screen 908, or in a case where the CPU 402 detects that the end button 967 is pressed in the explanation screen 907, the CPU 402 returns display of the LCD 608 to the guidance display screen 906.

Processing for returning to the guidance display screen 906 from the two-dimensional code screen 908 or the explanation screen 907 is summarized in the flowchart of FIG. 8. In S808, in a case where the CPU 402 detects that the back button 604 is pressed while the two-dimensional code screen 908 is displayed, the CPU 402 returns to S806 and displays the guidance display screen 906 on the LCD 608. Alternatively, in S808, in a case where the CPU 402 detects that the end button 967 is pressed while the explanation screen 907 is displayed, the CPU 402 returns to S806 and displays the guidance display screen 906 on the LCD 608.

The description continues with reference to the flowchart of FIG. 8. In a case where the processing returns from S808 to S806 and the CPU 402 detects pressing of the password entry button 964 in the next step S807, the CPU 402 displays, in S809, the password entry screen 909 (also referred to as a fourth screen) for accepting an entry of a connection password. That is, the password entry screen 909 (the fourth screen) is a screen for accepting an entry of a password for connection to a Wi-Fi router that is an AP. The password entry screen 909 of FIG. 9 is an example of a screen for entering a password for connection to a Wi-Fi router. The password entry screen 909 includes the password entry operation button 968 and the OK button 969. The relationship between pressing of the password entry operation button 968 and the OK button 969 and the processing flow is described in the next step.

Next, in S810, the CPU 402 determines whether an entry of a password for connection to a Wi-Fi router has been completed. In S810, first, in a case where the CPU 402 detects pressing of the password entry operation button 968, the CPU 402 displays a soft keyboard (not illustrated in the drawings) on the LCD 608. A password is entered using this soft keyboard. The CPU 402 accepts an entry of a password using this soft keyboard. Note that, not limited to the soft keyboard, the operation unit may include a keyboard. The CPU 402, upon detecting pressing of the OK button 969, determines that an entry of the password has been completed, and the processing proceeds to S811. Note that an entry of the password is performed by a user operation.

In S811, the NW sub-CPU 421 executes connection to the Wi-Fi router for which a password is entered in S810. While connection to the Wi-Fi router is being executed, the CPU 402 displays the AP connection screen 910 of FIG. 9 on the LCD 608.

Next, in S812, the NW sub-CPU 421 determines whether connection to the Wi-Fi router has succeeded. In a case where it is determined that connection to the Wi-Fi router has succeeded, the CPU 402 displays completion of connection to the Wi-Fi router on the operation unit, and ends the processing of the flowchart of FIG. 8. The connection completion screen 911 of FIG. 9 is an example of a screen displayed upon completion of connection to the Wi-Fi router. The connection completion screen 911 includes the OK button 970. In a case where the CPU 402 detects that the OK button 970 is pressed, the CPU 402 displays the default home screen 700 on the LCD 608, as illustrated in FIG. 9.

On the other hand, in a case where it is determined that connection to the Wi-Fi router has failed, the CPU 402 proceeds to S813. In S813, the CPU 402 displays, on the LCD 608, a screen indicating that connection to the Wi-Fi router has failed. The error screen 912 of FIG. 9 is an example of a screen indicating that connection to the Wi-Fi router has failed. Further, in the error screen 912, a message suggesting an incorrect entry of a password as a cause of the error is also displayed. The error screen 912 includes the OK button 971. The CPU 402, upon detecting that the OK button 971 is pressed, returns to S806.

Then, in S806, the CPU 402 displays again, on the LCD 608, the guidance display screen 906 for displaying the online manual in which an operation guide regarding an entry of a password for connection to a Wi-Fi router is described. In this way, a screen for guiding to an online manual in which an operation guide regarding an entry of a password is described is displayed in a case where connection to a Wi-Fi router has failed, thereby allowing a user to easily check the online manual. That is, usability in setting up a connection of the printer 102 to the AP 103 can be improved. Furthermore, regarding failure of connection to an AP, users can resolve the failure by themselves.

Through the above processing, in a case of setting up a connection of the printer 102 to a Wi-Fi router that is the AP 103, it is possible to guide a user to an online manual in which an operation guide regarding a password for connection to a Wi-Fi router is described. Further, by utilizing a two-dimensional code, the online manual can be displayed immediately and checked. Furthermore, also in a case where connection to a Wi-Fi router has failed, it is possible to similarly guide a user to the online manual in which an operation guide regarding a password is described. Therefore, even a user who is unfamiliar with setting up of a connection to a Wi-Fi router, particularly unfamiliar with an entry of a password, can surely set up a connection.

In this way, by application of the present embodiment, usability in a case of setting up a connection of a printer, which is a communication apparatus, to an AP is greatly improved.

### Second Embodiment

In the first embodiment, a description is given of an example in which, in a case of setting up a connection of a printer to a Wi-Fi router that is an AP, a user is guided to an online manual in which an operation guide regarding a password for connection to a Wi-Fi router is described. Furthermore, a description is given of an example in which, also in a case where connection to a Wi-Fi router has failed, a user is similarly guided to an online manual in which an operation guide regarding a password is described. In contrast, in the second embodiment, a description is given of an example in which, in a case where manual connection to a Wi-Fi router has already succeeded, the guidance display screen to an online manual is not displayed. Further, a description is also given of an example in which, in a case where a password of the printer 102 is incorrectly entered, a guidance screen to an online manual in which an operation guide is described is displayed. Furthermore, a description is given of an example in which, in a case where a two-dimensional code indicating the URL of an online manual has already been displayed once, the guidance screen to the online manual is not displayed. That is, the present embodiment is an example in which a screen for guiding to an online manual regarding a password for setting up a connection is displayed for a user who does not know the operation of entering a password of a Wi-Fi router.

In the following description, the same or corresponding configurations as those of the first embodiment are denoted by the same signs to omit explanations thereof, and the description focuses on points different from the first embodiment.

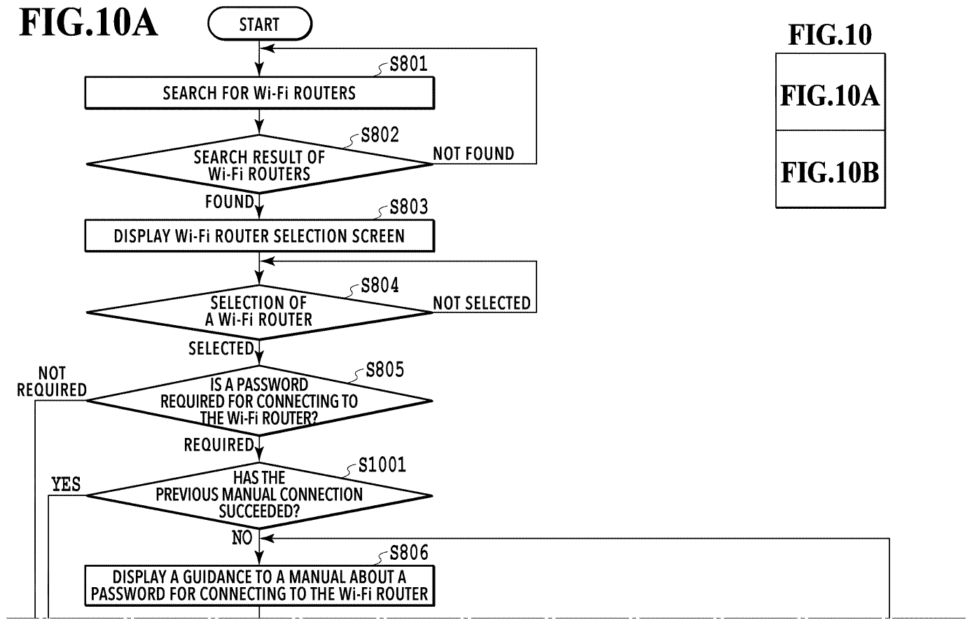

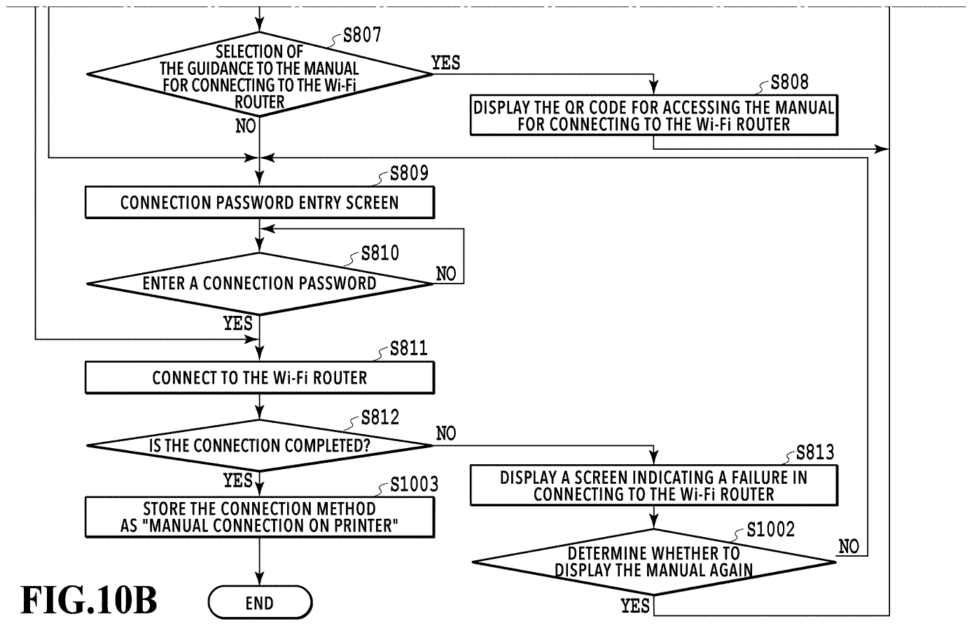

FIG. 10A and FIG. 10B are flowcharts for setting up a connection of the printer 102 to a Wi-Fi router serving the AP 103 in the second embodiment. In other words, they are flowcharts for setting up a connection of the printer 102 to a Wi-Fi network. S801 to S813 of FIG. 10A and FIG. 10B are the same as those of FIG. 8, which is a flowchart of the first embodiment. FIG. 10A and FIG. 10B, which are flowcharts of the present embodiment, differ from the flowchart of the first embodiment in that S1001, S1002, and S1003 are added. Therefore, the following description focuses on S1001, S1002, and S1003. However, for convenience of description, S1003 is described first, and thereafter, steps S1001 and S1002 are described in this order. Note that, in the present embodiment, screens displayed on the LCD 608 are the same as those in the first embodiment.

In the present embodiment, in a case where it is determined in S812 of FIG. 10B that the connection has been completed, in the next step S1003, the CPU 402 stores, in the non-volatile memory 405, that connection through the “MANUAL CONNECTION ON PRINTER” 958 is performed, as a connection method to a Wi-Fi router. That is, in a case where connection to a connection access point is performed through the “MANUAL CONNECTION ON PRINTER” 958 and the connection to the connection access point has succeeded, after completion of the connection, information related to the connection method is stored in the non-volatile memory 405 (also referred to as a first storage unit). Information related to the connection method is information indicating that the connection method is “MANUAL CONNECTION ON PRINTER” 958. The stored information is utilized for determining, in a case where setting up a connection to the same Wi-Fi router is required again, whether to display the guidance display screen 906 (the first screen). Note that, in the present embodiment, it is assumed to set up a connection to the same Wi-Fi router; however, it is not necessary to set up a connection to the same Wi-Fi router. In a case of setting up a connection to a different Wi-Fi router, the information indicating that “MANUAL CONNECTION ON PRINTER” 958 has been successfully performed may also be used. This is because it can be presumed that a user who has succeeded in manual connection with any Wi-Fi router is able to perform manual connection with another Wi-Fi router without checking an online manual.

In a case where setting up a connection to the same Wi-Fi router is required again, in S1001 of FIG. 10A, the CPU 402 determines whether the previous Wi-Fi manual connection has succeeded. The CPU 402 reads out the Wi-Fi connection method stored in the non-volatile memory 405, thereby determining whether the previous manual connection to a Wi-Fi router with the printer 102 has succeeded. That is, in a case where the connection method to the Wi-Fi router stored in the non-volatile memory 405 (the first storage unit) is “MANUAL CONNECTION ON PRINTER”, the CPU 402 determines that the previous Wi-Fi manual connection has succeeded. In other words, in a case where the connection method to a connection access point is the same as the connection method stored in the non-volatile memory 405 (the first storage unit), it is determined that the previous Wi-Fi manual connection has succeeded. On the other hand, in a case where the connection previously set up to a Wi-Fi router is other than “MANUAL CONNECTION ON PRINTER”, that is, in a case where the connection method is different from the connection method stored in the non-volatile memory 405 (the first storage unit), the CPU 402 determines that the previous Wi-Fi manual connection has not succeeded. In a case where it is determined that the previous Wi-Fi manual connection has succeeded, the CPU 402 proceeds to S809, and otherwise, the CPU 402 proceeds to S806.

In a case where it is determined in S1001 that the previous Wi-Fi manual connection has succeeded, in S809, the CPU 402 displays the password entry screen 909 for Wi-Fi connection in the same manner as in the first embodiment. That is, the CPU 402 displays the password entry screen 909 (the fourth screen) without displaying the guidance display screen 906 (the first screen). Note that, even in a case where the CPU 402 determines that the previous Wi-Fi manual connection has succeeded and the password entry screen 909 is displayed, by pressing the back button 604 of FIG. 6, it is possible to return to the guidance display screen 906 that guides to display an online manual. By returning to the guidance display screen 906, it is possible to check the online manual.

On the other hand, in a case where it is determined that the previous manual connection to a Wi-Fi router has failed, in S806, the CPU 402 displays, on the LCD 608, the guidance display screen 906 that guides to an online manual. Accordingly, in a case where the previous manual connection with the printer has succeeded, transition is made to the password entry screen 909 for the Wi-Fi router, assuming that the user knows the method of operating a password of a Wi-Fi router, thereby improving usability.

However, setting up a connection to a Wi-Fi router may fail. That is, there is a case in which, in S812 of FIG. 10B, the NW sub-CPU 421 determines that connection to a Wi-Fi router has failed. In this case, the CPU 402 proceeds to S813 and displays the error screen 912 indicating that connection to the Wi-Fi router has failed. Then, the CPU 402, upon detecting that the OK button 971 is pressed on the error screen 912, proceeds to S1002.

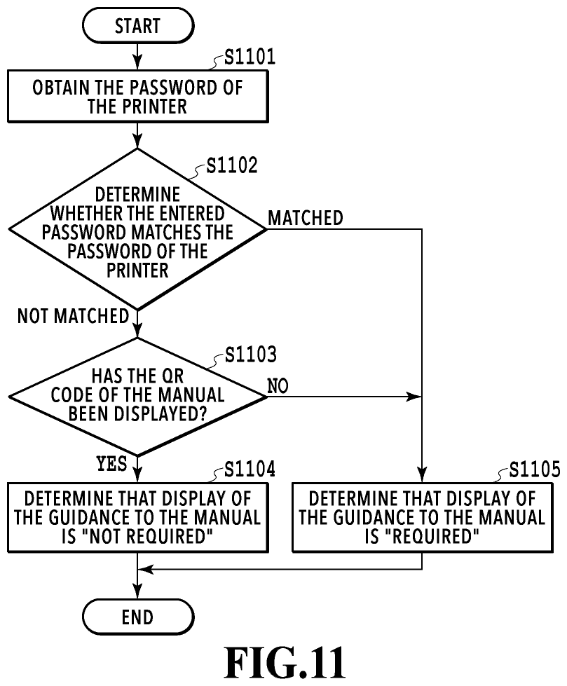

In S1002, whether to display the online manual again in which an operation guide regarding a password required for connection to a Wi-Fi router is described is determined. That is, in S1002, whether to display the contents of the guidance display screen 906 (the first screen) again is determined in a case where connection to the connection access point accepted by the CPU 402 has failed. In a case where it is determined that the online manual needs to be displayed again, the CPU 402 proceeds to S806, and otherwise, the CPU 402 proceeds to S809. Note that a detailed processing flow related to determination as to whether to display the online manual again in S1002 is described later with reference to FIG. 11.

As described in the first embodiment, in a case where the processing proceeds to S806, the CPU 402 displays, on the LCD 608, the guidance display screen 906 that guides to display an online manual including an operation guide regarding a password for a Wi-Fi router. On the other hand, in a case where the processing proceeds to S809, the CPU 402 displays the password entry screen 909 for Wi-Fi connection.

Next, a description is given about details of S1002, in which whether to display again an online manual regarding a password required for connection to a Wi-Fi router is determined. FIG. 11 is a flowchart illustrating details of S1002, in which whether to display an online manual again in which an operation guide regarding a password required for connection to a Wi-Fi router is described is determined.

First, in S1101, the CPU 402 reads out a password of the printer 102 stored in the non-volatile memory 405. Note that this password of the printer 102 is held in order to protect security for configuring settings of the printer main body via a network. Only in a case where this password is entered and matched, settings of the printer main body may be configured from a remote UI.

Next, in S1102, the CPU 402 determines whether a password for connecting to a Wi-Fi router entered in S809 (the password entry screen 909) matches the password of the printer 102. In S1102, in a case where it is determined that the passwords match, the CPU 402 proceeds to S1105, and in a case where it is determined that the passwords do not match, the CPU 402 proceeds to S1103.

In S1105, the CPU 402 determines that display of the guidance display screen 906 that guides to an online manual, which is an operation guide regarding a password, is “REQUIRED.” Accordingly, at the time of entering a password for connecting to a Wi-Fi router, in a case where a password of the printer is incorrectly entered, it is possible to guide again to display an online manual related to an entry of a password required for connection to the Wi-Fi router.

In a case where it is determined in S1102 that the passwords do not match, the CPU 402 determines in S1103 whether the QR code indicating the URL of an online manual in which an operation guide regarding a password is described has already been displayed. That is, in S1103, the CPU 402 determines whether the two-dimensional code screen 908 (the third screen) for accessing the online manual in which the operation guide regarding a password is described has already been displayed. This determination is performed by the CPU 402 reading out information (hereinafter referred to as two-dimensional code display information) indicating that a two-dimensional code has been displayed, which is stored in the RAM 404 (also referred to as a second storage unit). That is, in S808, where the two-dimensional code screen 908 is displayed, the CPU 402 stores, in the RAM 404 (the second storage unit), information indicating that the two-dimensional code screen 908 (the third screen) has been displayed, as the two-dimensional code display information. Further, the two-dimensional code display information stored in the RAM 404 is initialized in S801, at the start of setting up a connection to a Wi-Fi router. That is, in S801, the CPU 402 stores, in the RAM 404, information indicating that the two-dimensional code screen 908 has not yet been displayed, as the two-dimensional code display information. In S1102, the CPU 402 makes a determination by reading the two-dimensional code display information from the RAM 404. In a case where the CPU 402 determines that the two-dimensional code screen 908 has not been displayed, the processing proceeds to S1105, and in a case where the CPU 402 determines that the two-dimensional code screen 908 has been displayed, the processing proceeds to S1104.

In S1105, the CPU 402 determines that display of the guidance display screen 906 that guides to display an online manual is “REQUIRED”, and the CPU 402 ends the processing of the flowchart of FIG. 11.

On the other hand, in S1104, the CPU 402 determines that display of the guidance display screen 906 that guides to display an online manual is “NOT REQUIRED”, and the CPU 402 ends the processing of the flowchart of FIG. 11.

By the above processing, in a case where a connection is set up for the printer 102 to a Wi-Fi router that is the AP 103, on a condition that manual connection to a Wi-Fi router has already succeeded, it is possible not to display the screen that guides to display an online manual. Further, at the time of entering a password of a Wi-Fi router, in a case where the password of the printer 102 is incorrectly entered, it is possible to display the screen that guides to display an online manual. Furthermore, in a case where the two-dimensional code indicating the URL of an online manual has been displayed once, it is possible not to display the screen that guides to display an online manual. Accordingly, in a case where the previous manual connection with the printer has succeeded, unnecessary operations are omitted on an assumption that the user knows the method of operating a password of a Wi-Fi router, and transition is made to the password entry screen 909, thereby improving usability. Contrarily, in a case where the user does not know the operation of setting up of a connection to a Wi-Fi router, in particular, the operation of entering a password, such as a case in which the password of the printer 102 is incorrectly entered, it is possible to display a screen that guides to display an online manual.

In this way, by application of the present embodiment, usability in a case of setting up a connection of a printer, which is a communication apparatus, to an AP is greatly improved.

### Third Embodiment

In the first embodiment, a description is given of an example in which, in a case of setting up a connection of a printer to a Wi-Fi router that is an AP, a user is guided to an online manual in which an operation guide regarding a password for connection to a Wi-Fi router is described. Furthermore, a description is given of an example in which, also in a case where connection to a Wi-Fi router has failed, a user is similarly guided to an online manual in which an operation guide regarding a password is described. In contrast, in the third embodiment, a description is given about an example in which, not only is an online manual displayed on a mobile terminal device using a two-dimensional code, but an operation guide for entering a Wi-Fi password is also displayed on the LCD 608, thereby making it possible to check the operation method more easily. Note that, in the present embodiment, the flowchart is the same as that in FIG. 8 of the first embodiment, but the screens displayed on the LCD 608 are different from those in the first embodiment. In the following description, the same or corresponding configurations as those of the first embodiment are denoted by the same signs to omit explanations thereof, and the description focuses on points different from the first embodiment.

In FIG. 12, an example of the operation screens displayed on the LCD 608 in the present embodiment is illustrated. The default home screen 700, the LAN setting screen 901, the Wi-Fi screen 902, the Wi-Fi setup screen 903, the AP search screen 904, and the Wi-Fi router selection screen 905 are the same as those in FIG. 9 of the first embodiment. Further, the two-dimensional code explanation screen 907, the two-dimensional code screen 908, the password entry screen 909, the AP connection screen 910, the connection completion screen 911, and the error screen 912 are also the same as those in FIG. 9 of the first embodiment. FIG. 12 of the present embodiment differs from the first embodiment in that the guidance display screen 1201 for displaying an operation guide is included in place of the guidance display screen 906 in FIG. 9, and in that the operation guide display screen 1202 (also referred to as a fifth screen) is further included. Note that, since the guidance display screen 1201 for displaying an operation guide has the same function as the guidance display screen 906, the guidance display screen 1201 is also referred to as the first screen. Further, in the following description, the guidance display screen 1201 for displaying an operation guide is simply referred to as the guidance display screen 1201.

The guidance display screen 1201 includes the password entry button 964 and the operation guide display button 1210 (also referred to as a third operation area). The guidance display screen 1201 is displayed on the LCD 608 at the time of S806 in the flowchart of FIG. 8. The password entry button 964 has the same function as the button arranged on the guidance display screen 906 of FIG. 9. The operation guide display button 1210 (the third operation area) is operated at the time of transitioning to the operation guide display screen 1202 (the fifth screen). The CPU 402, upon detecting that the operation guide display button 1210 (the third operation area) is pressed, displays, on the LCD 608, the operation guide display screen 1202 (the fifth screen) before displaying the two-dimensional code explanation screen 907 (the second screen). Pressing of the operation guide display button 1210 (the third operation area) is performed by a user operation.

The operation guide display screen 1202 is displayed on the LCD 608 at the time of S808 in the flowchart of FIG. 8. The operation guide display screen 1202 includes the QR code button 1211 (also referred to as a fourth operation area) and the end button 967. Furthermore, the operation guide illustration 1213 is displayed on the operation guide display screen 1202. The operation guide illustration 1213 may include an illustration of a Wi-Fi router main body. In the present embodiment, the operation guide illustration 1213 includes, as well as an illustration of a Wi-Fi router main body, an illustration indicating a portion where a password for connection to a Wi-Fi router is written. That is, the operation guide illustration 1213 is an operation guide indicating the portion where the password for connection to the Wi-Fi router is written. In other words, the operation guide illustration 1213 is an operation guide that displays the portion where the password for connection to the Wi-Fi router is written in a visually easy-to-understand manner.

Further, in the operation guide display screen 1202, upon detecting that the QR code button 1211 (the fourth operation area) is pressed, the CPU 402 displays the explanation screen 907 (the second screen) that explains the two-dimensional code screen 908. Then, upon detecting that the QR code button 966 of the explanation screen 907 is pressed, the CPU 402 displays the two-dimensional code screen 908. That is, the operation guide display screen 1202 (the first screen) is also capable of guiding to the two-dimensional code screen 908 (the third screen), which is the contents of a URL for accessing an online manual. In this manner, also in the present embodiment, it is possible to guide to display an online manual in which an operation guide regarding a password required for connection to a Wi-Fi router is described. Note that pressing of the QR code button 1211 is performed by a user operation.

In a case where the CPU 402 detects that the end button 1212 of the operation guide display screen 1202 or the end button 967 of the two-dimensional code explanation screen 907 is pressed, the CPU 402 displays the guidance display screen 1201. Alternatively, also in a case where the CPU 402 detects that the back button 604 is pressed while the two-dimensional code screen 908 is displayed, the CPU 402 displays the guidance display screen 1201. Further, the CPU 402 detects that the password entry button 964 of the guidance display screen 1201 is pressed, thereby causing the CPU 402 to display the password entry screen 909. As described above, an entry of a password can be performed from the password entry screen 909.

As described above, in the present embodiment, a method for checking a password for connecting the printer 102 to a Wi-Fi router can be checked on the LCD 608 (the operation display unit 410). Moreover, in the present embodiment, the operation guide illustration 1213 is displayed on the LCD 608. The operation guide illustration 1213 is an operation guide indicating the portion where the password of the Wi-Fi router is written on a Wi-Fi router main body. By checking this illustration, the user can check, more easily and in a visually easy-to-understand manner, where the password of the Wi-Fi router is written.

In this way, by application of the present embodiment, usability in a case of setting up a connection of a printer, which is a communication apparatus, to an AP is greatly improved.

As described above, the control in each of the above embodiments described as being performed by the CPU 402 of the printer 102 may be performed by one piece of hardware, or control of the entire apparatus may be performed by multiple pieces of hardware sharing processing. Note that the multiple pieces of hardware refer to, for example, multiple processors or multiple circuits.

Further, although the present invention is described above in detail based on embodiments thereof, the present invention is not limited to these specific embodiments, and, various forms are also included in the present invention to the extent not departing from the gist of this invention. Moreover, each of the above-described embodiments merely shows one embodiment of the present invention, and it is also possible to appropriately combine each of the embodiments.

Further, in each of the above-described embodiments, an image forming apparatus is described as an example of a communication apparatus; however, the communication apparatus is not limited to an image forming apparatus. Any apparatus may be used as long as the apparatus is capable of connecting to a Wi-Fi router by an operation on the communication apparatus main body side. Further, as described in the above embodiments, in a case where a password for accessing a communication apparatus main body is present, there may be a case in which the password is confused with a password for connecting to a Wi-Fi router. Therefore, in a case where a password for accessing the communication apparatus main body is present, each of the above-described embodiments is useful.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to improve usability in a case of setting up a connection of a communication apparatus to an access point.

This application claims the benefit of Japanese Patent Application No. 2025-054524, filed Mar. 27, 2025, which is hereby incorporated by reference herein in its entirety.

What is claimed is:

1. A communication apparatus capable of communicating with an external access point, the communication apparatus comprising:
one or more processors; and
one or more memories storing instructions that, when executed by the one or more processors, cause the communication apparatus to:
accept, from among one or more access points that are candidates for a connection destination, selection of a connection access point to which a connection is set up; and
control such that, in a case where an entry of a password is not required for connecting to the connection access point for which the selection is accepted, a first screen for guiding to an operation guide regarding the password is not displayed, and, in a case where an entry of the password is required, the first screen is displayed.

2. The communication apparatus according to claim 1,
wherein the operation guide is an online manual.

3. The communication apparatus according to claim 2,
wherein the first screen includes a first operation area for transitioning to a second screen for displaying a two-dimensional code for accessing the online manual,
wherein the second screen includes a second operation area for transitioning to a third screen in which the two-dimensional code is displayed, and
wherein the instructions further cause the communication apparatus to:
control to display the second screen from the first screen, based on a user operation on the first operation area in the first screen; and
control to display the third screen from the second screen, based on a user operation on the second operation area in the second screen.

4. The communication apparatus according to claim 1,
wherein the instructions further cause the communication apparatus to:
search for the one or more access points that are connectable; and
determine whether an entry of a password is required for connecting to the connection access point, based on information related to security settings of the access points, which is obtained during the search for the access points.

5. The communication apparatus according to claim 1,
wherein the instructions further cause the communication apparatus to:
control to display the first screen in a case where connection to the connection access point fails after the first screen is displayed.

6. The communication apparatus according to claim 1,
wherein the communication apparatus further comprises a first storage unit, and
wherein the instructions further cause the communication apparatus to:
perform connection to the connection access point by manual connection performed on the communication apparatus, and, in a case where the connection to the connection access point succeeds, store, in the first storage unit, information indicating that a connection method for connecting to the connection access point is manual connection;
control to display the first screen in a case where a connection method for connecting to the connection access point for which the selection is accepted is different from the connection method stored in the first storage unit; and
control to display a fourth screen for accepting an entry of a password without displaying the first screen in a case where a connection method for connecting to the connection access point for which the selection is accepted is the same as the connection method stored in the first storage unit.

7. The communication apparatus according to claim 1,
wherein the instructions further cause the communication apparatus to:
determine whether to display the first screen again in a case where connection to the connection access point fails after the first screen is displayed.

8. The communication apparatus according to claim 7,
wherein the instructions further cause the communication apparatus to:
determine to display the first screen again in a case where it is determined that a password entered at the time the connection to the connection access point fails matches a password of the communication apparatus.

9. The communication apparatus according to claim 7,
wherein the communication apparatus further comprises a second storage unit,
wherein the operation guide is an online manual, and
wherein the instructions further cause the communication apparatus to:
store, in the second storage unit, information indicating that a third screen in which a two-dimensional code for accessing the online manual via the first screen is displayed has been displayed, the information being initialized at a start of setting up a connection to the connection access point; and
determine to display the first screen again in a case where the information indicating that the third screen has been displayed is not stored in the second storage unit.

10. The communication apparatus according to claim 2,
wherein the first screen includes a third operation area for transitioning to a fifth screen indicating a portion where a password is written on the external access point,
wherein the fifth screen includes a fourth operation area for transitioning to the second screen for displaying a two-dimensional code for accessing the online manual, and
wherein the instructions further cause the communication apparatus to:
control to display the fifth screen before displaying the second screen, based on a user operation on the third operation area in the first screen.

11. The communication apparatus according to claim 10,
wherein the instructions further cause the communication apparatus to:
control to display the second screen from the fifth screen, based on a user operation on the fourth operation area in the fifth screen.

12. The communication apparatus according to claim 10,
wherein the instructions further cause the communication apparatus to:
display, on the fifth screen, an illustration including a main body of the external access point and a portion where the password is written.

13. The communication apparatus according to claim 1,
wherein the one or more access points are Wi-Fi routers.

14. A method for controlling a communication apparatus capable of communicating with an external access point, the method comprising:
accepting, from among one or more access points that are candidates for a connection destination, selection of a connection access point to which a connection is set up; and
controlling such that, in a case where an entry of a password is not required for connecting to the connection access point for which the selection is accepted, a first screen for guiding to an operation guide regarding the password is not displayed, and, in a case where an entry of the password is required, the first screen is displayed.

15. A non-transitory computer readable storage medium storing a program which causes a computer to function as a communication apparatus capable of communicating with an external access point, the communication apparatus comprising:
an accepting unit configured to accept, from among one or more access points that are candidates for a connection destination, selection of a connection access point to which a connection is set up; and
a display control unit configured to control such that, in a case where an entry of a password is not required for connecting to the connection access point for which the selection is accepted, a first screen for guiding to an operation guide regarding the password is not displayed, and, in a case where an entry of the password is required, the first screen is displayed.

16. The non-transitory computer readable storage medium according to claim 15,
wherein the operation guide is an online manual.

17. The non-transitory computer readable storage medium according to claim 16,
wherein the first screen includes a first operation area for transitioning to a second screen for displaying a two-dimensional code for accessing the online manual,
wherein the second screen includes a second operation area for transitioning to a third screen in which the two-dimensional code is displayed, and
wherein the display control unit is configured to:
display the second screen from the first screen, based on a user operation on the first operation area in the first screen; and
display the third screen from the second screen, based on a user operation on the second operation area in the second screen.

18. The non-transitory computer readable storage medium according to claim 15,
wherein the communication apparatus further comprises a search unit configured to search for the one or more access points that are connectable, and
wherein the display control unit is configured to determine whether an entry of a password is required for connecting to the connection access point, based on information related to security settings of the access points, which is obtained during the search for the access points performed by the search unit.

19. The non-transitory computer readable storage medium according to claim 15,
wherein the display control unit is configured to display the first screen in a case where connection to the connection access point fails after the first screen is displayed.

20. The non-transitory computer readable storage medium according to claim 15,
wherein the communication apparatus further comprises a first storage unit configured such that, in a case where connection to the connection access point is performed by manual connection performed on the communication apparatus and the connection to the connection access point succeeds, the first storage unit stores information indicating that a connection method for connecting to the connection access point is manual connection, and
wherein the display control unit is configured to
display the first screen in a case where a connection method for connecting to the connection access point for which the selection is accepted by the accepting unit is different from the connection method stored in the first storage unit, and
display a fourth screen for accepting an entry of a password without displaying the first screen in a case where a connection method for connecting to the connection access point for which the selection is accepted by the accepting unit is the same as the connection method stored in the first storage unit.
